(19) United States
(12) Patent Application Publication
(10) Pub. No.: US 2025/0155645 A1
(43) Pub. Date: May 15, 2025

(54) TAPERED FIBER WITH A NON-CIRCULAR CROSS-SECTION

(71) Applicant: CORNING INCORPORATED, CORNING, NY (US)

(72) Inventors: Santanu Basu, Chevy Chase, MD (US); Ming-Jun Li, Horseheads, NY (US)

(21) Appl. No.: 18/939,882

(22) Filed: Nov. 7, 2024

Related U.S. Application Data
(60) Provisional application No. 63/599,059, filed on Nov. 15, 2023.

(51) Int. Cl. G02B 6/30

(52) U.S. Cl. CPC G02B 6/30

(57) ABSTRACT

A fiber to waveguide coupler is provided that includes an optical fiber having a core and a cladding. One end of the optical fiber is tapered and has a non-circular cross-section. The optical fiber defines a stripped portion to expose the at least one substantially flat surface of the fiber. A waveguide is configured to be evanescently coupled with the exposed at least one substantially flat surface of the fiber.

### CROSS-REFERENCE TO RELATED APPLICATIONS

This application claims the benefit of priority to U.S. Provisional Patent Application No. 63/599,059 filed on Nov. 15, 2023, the content of which is incorporated herein by reference in its entirety for all purposes.

### BACKGROUND

The present disclosure generally relates to an optical fiber suitable for coupling to a nanophotonic waveguide and more particularly, relates to tapered optical fiber with a noncircular cross-section, for example a D-shaped fiber suitable for evanescent coupling to a nanophotonic waveguide of the photonic integrated circuits.

Conventional photonic integrated circuits typically utilize both a silicon waveguide and a polymer waveguide which are evanescently coupled on the photonic integrated circuit (PIC). An optical fiber is then coupled to the polymer waveguide for providing optical signals to or from the photonic circuit. Coupling between the polymer waveguide and a typical optical fiber may result in 1 dB of loss. The loss is determined by mode-matching loss, optical misalignment loss, polarization-mismatch loss, and absorption and scattering losses at the interface.

Of particular interest is an interface between an array of optical fibers and an array of optical waveguides on PIC, which is of considerable complexity. Various methods of coupling the fiber to the circuit try to improve the signal loss, but generally will increase the fabrication complexity and cost of the fiber and/or the circuit, or decrease the bandwidth or channels. Some of the suggested approaches requires considerable high-precision fiber-to-waveguide alignment which increase complexity and coupling cost of multiple optical fiber to an array with large waveguide count that is required in typical PICs.

Waveguides on silicon, silicon nitride, diamond and other semiconductor substrates are typically utilized for routing optical signals among light sources, detectors, modulators, cavities, nonlinear optical devices and other components in wafer level integrated devices. Due to high refractive index of silicon, GaAs, Lithium Niobate and other common materials used in photonic integrated circuits (PIC), the mode size and the dimensions of single mode waveguide can be small, for example less than 1 micron. On the other hand, the mode diameter in a typical single mode optical fiber is around 4-11 micron. Alignment of the optical fiber to the waveguide is also a critical design consideration to enable low loss coupling. In a typical PIC chip, there may be an array of waveguides which need to be coupled to an array of fibers. Initial alignment and maintenance of alignment in operation between each waveguide and its corresponding fiber in the array is often a significant technical challenge. Furthermore, coupling fibers together results in additional signal loss.

Accordingly, a new manner of transmitting optical signals between optical fibers and/or photonic circuits is desirable. A new approach for coupling an array of fibers to an array of waveguides on PIC is also desirable.

### SUMMARY

According to some embodiments of the present disclosure, a fiber to waveguide coupler is provided that includes an optical fiber having a core and a cladding. The optical fiber has a non-circular cross-section and at least one end of optical fiber is tapered.

According to some embodiments of the present disclosure, a fiber to waveguide coupler comprises: a non-circularly shaped optical fiber having a core and a cladding, at least one of the core and the cladding defining a substantially flat surface angled with respect to an axis of the optical fiber, wherein the optical fiber defines a stripped portion substantially free of the cladding configured to expose the at least one substantially flat surface of the core; and a waveguide situated adjacent to the core and configured to evanescently couple with the fiber through the exposed at least one substantially flat surface of the core. According to at least some embodiments, a waveguide is configured to be evanescently coupled with the core through the exposed at least one substantially flat surface of the core.

According to some embodiments, optical fiber cladding has a D-shape cross-section. According to some embodiments, at least a portion of the optical fiber is tapered. According to some embodiments, a cross-section of the core has a minimum width of less than 7 μm.

According to some embodiments of the present disclosure, a fiber to waveguide coupler is provided that includes an optical fiber having a core and a cladding. The optical fiber cross-section has a D-shaped core and at least one end of optical fiber is tapered.

According to some embodiments, at least one of the core and inner cladding of the optical fiber defines a substantially flat surface that is angled relative to an axis of the optical fiber. According to at least some embodiments, the fiber is configured to be evanescently coupled to the waveguide of a photonic integrated circuit with the core through the exposed at least one substantially flat surface of the core.

According to some embodiments, the cladding may include an inner cladding and an outer cladding with a polymer. At least one of the core and inner cladding defines a substantially flat surface angled relative to an axis of the optical fiber.

According to another embodiment of the present disclosure, a method of evanescent coupling is provided that includes the steps: providing an optical fiber with a non-circular cross-section, the optical fiber having a core and at least one cladding; tapering the optical fiber; providing a photonic integrated circuit comprising a waveguide; stripping a portion of the outer cladding to expose at least a portion of the substantially flat surface; and positioning the stripped portion of the optical fiber such that the substantially flat surface is proximate the waveguide and the core is evanescently coupled with the waveguide.

According to yet another embodiment, a method of evanescently coupling is provided that includes the steps of providing an optical fiber having a core and a cladding which may includes a polymeric material; preferentially stripping a portion of the of the cladding from the optical fiber at an angle relative to fiber axis and creating a flat surface; providing a waveguide; and positioning the core of the optical fiber sufficiently close to the wave guide to evanescently couple the core of the optical fiber to the waveguide.

According to yet another embodiment of the present disclosure, an optical fiber is provided which includes a glass core and a cladding. The cladding may include an inner glass cladding and an outer cladding having a polymer. The cladding defines a substantially flat surface angled with relative to an axis of the optical fiber. According to at lest one embodiment an optical fiber comprises: a glass core and a D-shaped cladding, wherein a portion of the cladding defines a substantially flat surface angled to an axis of the optical fiber.

Additional features and advantages will be set forth in the detailed description which follows, and, in part, will be readily apparent to those skilled in the art from that description or recognized by practicing the embodiments as described herein, including the detailed description which follows the claims, as well as the appended drawings.

It is to be understood that both the foregoing general description and the following detailed description are merely exemplary and are intended to provide an overview or framework to understanding the nature and character of the claims. The accompanying drawings are included to provide a further understanding, and are incorporated in and constitute a part of this specification. The drawings illustrate one or more embodiments, and together with the description serve to explain principles and operation of the various embodiments.

### BRIEF DESCRIPTION OF THE DRAWINGS

FIG. 1 shows is cross sectional views of a stripped optical fiber, as well as perspective view of a stripped portion of an optical fiber, according to one embodiment;

FIG. 2A is an enlarged cross-sectional view of an optical fiber, according to one embodiment;

FIG. 2B is an enlarged cross-sectional view of an optical fiber, according to one embodiment;

FIG. 3A is an enlarged cross-sectional view of an optical fiber, according to one embodiment;

FIG. 3B is an enlarged cross-sectional view of an optical fiber, according to one embodiment;

FIG. 3C is an enlarged cross-sectional view of an optical fiber, according to one embodiment;

FIG. 3D is an enlarged cross-sectional view of a manufactured optical fiber, according to one embodiment;

FIG. 4 illustrates a photonic integrated circuit with multiple waveguides according to one embodiment;

FIG. 5 is a perspective view of a coupler for connecting one optical fiber to an optical fiber with stripped portion, according to one embodiment;

FIGS. 6A-6D illustrate perspective views of an optical fiber evanescently coupling with a photonic integrated circuit and exemplary method of coupling an optical fiber to a photonic integrated circuit, according to one embodiment;

FIGS. 7A-7B illustrates a D-shaped optical fiber with multiple cores coupled to a waveguide with multiple waveguides a photonic integrated circuit, according to one embodiment;

FIG. 8 illustrates a ribbon of multiple arrayed D-shaped fibers for coupling with multiple waveguides on photonic integrated circuit, according to one embodiment.

### DETAILED DESCRIPTION

Reference will now be made in detail to the present embodiments, examples of which are illustrated in the accompanying drawings. Whenever possible, the same reference numerals will be used throughout the drawings to refer to the same or like parts.

For purposes of description herein, the terms “upper,” “lower,” “right,” “left,” “rear,” “front,” “vertical,” “horizontal,” and derivatives thereof, shall relate to the disclosure as oriented in FIG. 1, unless stated otherwise. However, it is to be understood that the disclosure may assume various alternative orientations, except where expressly specified to the contrary. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting unless the claims expressly state otherwise. Additionally, embodiments depicted in the figures may not be to scale or may incorporate features of more than one embodiment.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

Low loss coupling of a diamond waveguide in the substrate to an optical fiber that can carry the optical signals in and out of the substrate is important. This can be done through evanescent wave coupling between a waveguide and the optical fiber. To enhance the coupling efficiency, both the waveguide and the optical fiber can tapered, which allows for adiabatic transfer of the fundamental mode of the optical fiber to that of the waveguide. However, evanescent wave coupling efficiency is very sensitive to alignment. In practice, the tapered fiber tip of each fiber needs to be aligned to the tapered waveguide using high-precision opto-mechanical stages with six degrees of freedom of motion. Holding the tapered fiber steady is a challenge by itself. When an array of tapered waveguides which are lithographically fabricated and are on a common surface need to be coupled to multiple tapered fibers which are in free space with no geometrical alignment with respect to one another in the fiber array, aligning each fiber to each waveguide of the PIC array with six-axis opto-mechanical stages becomes difficult and/or impractical.

However, we discovered that that use of a non-symmetrical fiber with one rounded outer surface and one flat outer surface such as, for example, a tapered D-shaped optical fiber 10 solves this problem. A D-shaped fiber is an optical fiber with a D-shaped cladding-i. e., a cladding that has a cross-section with a substantially flat surface F, and a rounded surface R connected to the flat surface. A tapered D-shaped fiber can be easily aligned with high coupling efficiency and inexpensively coupled to a nanophotonic waveguide in a PIC substrate. Tapering in the D-shaped fiber can be done, for example, by laser processing or by polishing the fiber adjacent to fiber end. Using a tapered D-shaped fiber also reduces coupling length between the waveguide and the optical fiber, which can save space on a chip, or result in a smaller chip.

The taper angle θ is designed for optimal coupling to the nanophotonic waveguide on the PIC chip and the optimum angle will vary from waveguide to waveguide the fiber needs to be coupled to. The discovery that a tapered D-shaped fibers can be an efficient coupler to nanophotonic waveguides was surprising, and offers one or more of the following advantages: (1) it results in significantly fewer number of alignment steps between the waveguides and fiber cores; (2) ease of manufacture (it is easier to fabricate a tapered D-shaped fiber with multiple cores as compared to fabrication of a large number of fibers with identical conically tapered ends); (3) better quality coupling due to low coupling loss across the array of multiple waveguides; (4) it enables new applications requiring interfaces with arrays containing a large number of waveguides.

The tapering of the D-shaped fiber can be also achieved, for example, one of the following two methods:
(i) Trimming the flat portion of the fiber's cladding at an angle in a fiber section to gradually reduce the surface distance from the core. (FIG. 1). The fiber core diameter and the cladding diameter remain unchanged.
(ii) Stretching a part of the fiber to reduce the fiber diameter. This method reduces the fiber core diameter.

The taper is designed for optimal coupling to the nanophotonic waveguide on the PIC chip and the optimum taper angle θ will vary depending on waveguide's size/or shape that the fiber needs to be coupled to. D-shaped fibers can be an efficient coupler to nanophotonic waveguides and offer one or more of the following advantages: (1) it results in significantly fewer number of alignment steps between the waveguides and fiber cores; (2) ease of manufacture (it is easier to fabricate a tapered D-shaped fiber with multiple cores as compared to fabrication of a large number of fibers with identical conically tapered ends); (3) better quality coupling due to low coupling loss across the array of multiple waveguides; (4) it enables new applications requiring interfaces with arrays containing a large number of waveguides.

Other advantages for use of the tapered D-shaped fiber(s) are: the coupling interface is flat allowing for ease of contact/alignment with planar waveguides on PIC chips; the tapering exposes the core allowing for more efficient evanescent wave coupling; flat surfaces offer much larger contact area for efficient power coupling; and adiabatic transfer of fundamental mode from the waveguide to the fiber in an optimally tapered design.

According to some embodiments, a fiber to waveguide coupler comprises: a non-circularly shaped optical fiber 10 having a core and a cladding, at least one of the core and the cladding defining a substantially flat surface angled with respect to an axis (of symmetry) of the optical fiber, wherein the optical fiber defines a stripped portion substantially free of the cladding configured to expose the at least one substantially flat surface of the core; and a waveguide situated adjacent to the core and configured to evanescently couple with the fiber through the exposed at least one substantially flat surface of the core. (The axis of the optical fiber, as referred to herein, is situated on a flat and horizontal potion of the fiber cladding, thus the substantially flat surface angled with respect to the flat, unstripped surface of the fiber.) According to at least some embodiments, a waveguide is configured to be evanescently coupled with the core through the exposed at least one substantially flat surface of the core.

According to some embodiments, optical fiber cladding has a D-shape cross-section. According to some embodiments, at least a portion of the optical fiber is tapered. According to some embodiments, a cross-section of the core has a minimum width of less than 7 μm.

FIG. 1, depicts is an embodiment optical fiber 10 suitable for coupling to a photonic integrated circuit (PIC). The cross section of the optical fiber shown in FIG. 1 is D shaped-i .e., it's cladding has a truncated circular profile terminated with a chord. The core may be situated 2-10 microns away from the flat surface of the cladding. The core may be circular, rectangular, or D-shaped. The tapered D-shaped fiber can be made in several ways, for example s pulling the D-shaped fiber from a D-shaped preform, or by laser processing. For example, as stated above, the tapering in the D-shaped fiber can be done by laser processing or by polishing of the cladding, for example to expose the fiber core. When the tapered D shaped fiber section is coupled to the waveguide, the light from the core is leaked more and more along the taper, thus facilitating efficient the coupling from the chip to fiber.

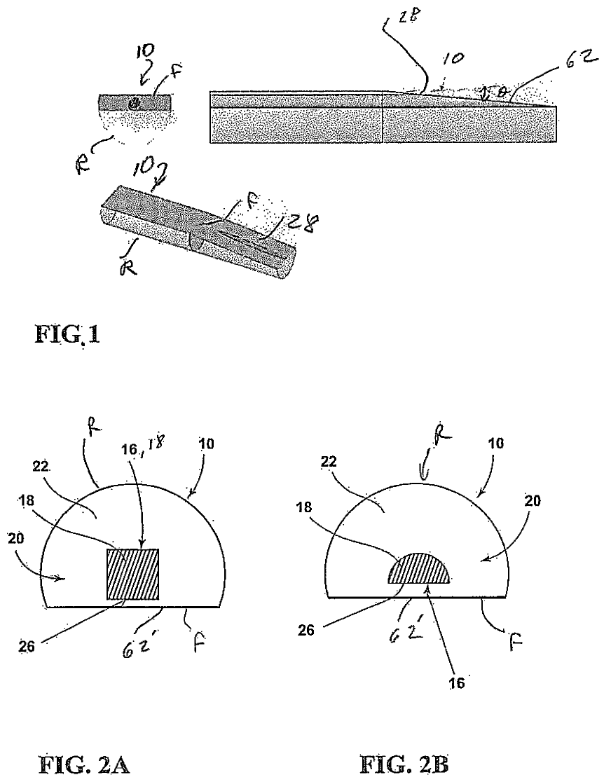

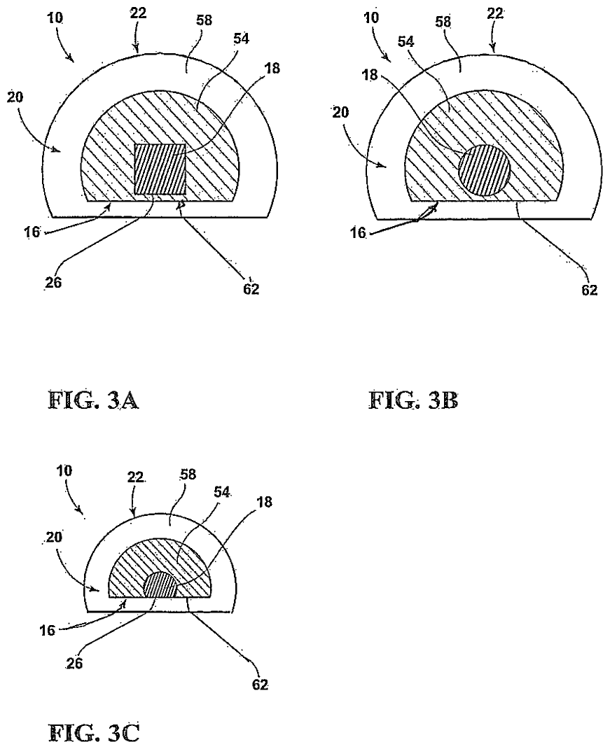

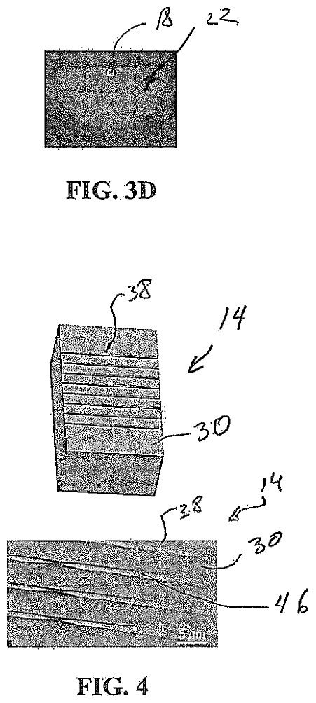

As shown in FIGS. 2A, 2B and 3A-3D, the optical fiber 10 may include a glass portion 16 and a polymeric portion 20. The glass portion 16 includes a core 18 and may include an inner cladding 54 (FIG. 3A). The polymeric portion 20 may include an outer cladding 58 (FIG. 3A) positioned around the glass portion 16. The inner cladding 54 and the outer cladding 58 may cooperate to form a cladding 22 disposed around the core 18. The glass portion 16 may define one or more substantially flat surfaces, for example a core surface 26 (FIGS. 3A-3C) or a cladding surface 62 (FIGS. 3A-3C). The flat surfaces (e.g., core surface 26 or cladding surface 62) are angled with respect the axis of the fiber 10 for either a portion of the fiber 10 or the entire length of the fiber 10. The optical fiber 10 may include one or more stripped portions 28 where a at least a portion of the cladding has been removed or stripped from the optical fiber 10 such that one or more of the flat surfaces (e.g., the core surface 26 and/or cladding surface 62) are exposed. The glass core 18 may be composed of pure silica, doped silica (e.g., doped with germanium, aluminum, and/or chlorine) and/or other optically transparent materials. The optional inner cladding 54 may be composed of pure silica, doped silica (e.g., fluorine and/or boron) or other optically transparent materials. The optical fiber 10 may be a single mode fiber or may be a multi-mode fiber. The core 18 may have a higher refractive index than the inner cladding 54. The core 18 may have a relative refractive index change, or delta, relative to the inner cladding 54 in the range of about 0.2% to about 3.0%, for example about 0.34%, about 0.5%, about 1.0%, about 1.5%, about 2.0%, about 2.5% or about 3.0%. The core 18, and the cladding (e.g., inner cladding 54 and/or outer cladding 58) may be tapered. The cladding 22 may be a composite (e.g., inner cladding 54 is composed of glass and the outer cladding 58/polymeric portion 20 is composed of a polymer). The refractive indexes of the materials of the cladding 22 may have a lower refractive index than the core 18. It will be understood that the optical fiber 10, as described herein, may simply be a connection or connector to another longer or larger optical fiber. According to some embodiments, the optical fiber 10 may include multiple glass cores 18 situated within a common cladding.

Referring to FIG. 4, the photonic integrated circuit 14 includes a substrate 30 and at least one waveguide 38. Waveguide(s) 38 may include silicon, silicon nitride, glass, polymers, combinations thereof and/or other materials. FIG. 4 illustrates a typical PIC chip with an array of nanophotonic waveguides. The waveguides are typically strip waveguide or rib waveguide. For interfacing with other components, the waveguides 38 are sometimes tapered to change the fundamental mode properties. A nanophotonic waveguide 38 designed for an operating wavelength in 1300-1550 nm range is typically 100-1,000 nm in width and less than 100-500 nm in height depending on the substrate (silicon, diamond etc.). Some waveguides may be significantly smaller, for example less than 10 nm wide. For example, due to high refractive index of silicon, GaAs, Lithium Niobate and other common materials used in photonic integrated circuits (PIC), the mode size and the waveguide dimensions less than 1 micron. Typical PIC substrates 30 may include silicon, silicon nitride, diamond and/or gallium arsenide.

The substrate 30 may be a silicon substrate, glass substrate or other support structure capable of supporting and defining optical devices. The waveguide(s) 38 may be planar. The waveguide(s) 38 may be a silicon waveguide 38 configured to carry an optical signal along the photonic integrated circuit 14 to a detector or other optical circuitry located on or off the circuit 14. The waveguide(s) 38 may have a mode field diameter similar to that of the optical fiber 10 and may be either not tapered or tapered in a direction transverse to the direction of light propagation along the length of the waveguide 38. The waveguide(s) 38 may be tapered, or reduced, to less than about 70%, less than about 60%, or less than about 50% of its original width (e.g., from about 200 nm to about 120-160 nm). Doping of the core 18 may facilitate a less narrow taper of the waveguide 38 to be achieved. The waveguide 38 defines a waveguide surface 46 which may be substantially flat and configured to couple with the core 18 through the core surface 26 and/or the cladding surface 62 of the inner cladding 54.

The optical fiber 10 is configured to carry one or more optical signals along the core 18. The placement of the stripped portion 28 of the optical fiber 10 adjacent to the flat surface of the waveguide places the optical fiber 10 in close, intimate, contact with the waveguide 38 such that optical signals may be transferred between the two. For example, the core surface 26 and/or the cladding surface 62 of the stripped portion 28 are sufficiently proximate to the waveguide surface 46 of the waveguide 38 in the plane of the substrate 30 for an evanescent field of light propagating through the optical fiber 10 to enter the waveguide 38, or vice versa. Evanescent coupling between the optical fiber 10 and the waveguide 38 may transfer greater than about 50%, greater than about 60%, greater than about 70%, greater than about 80%, greater than about 90%, or about substantially 100% of the optical power between the optical fiber 10 and the waveguide 38. The core surface 26 and/or cladding surface 62 may overlap the waveguide surface 46 of the waveguide 38 between about 10 μm and about 3000 μm to facilitate evanescent coupling. The waveguide 38 may be tapered. The tapering in the D-shaped fiber can be done, for example, by laser processing or by polishing. The taper angle of the D-shaped fiber is designed for optimal coupling to the nanophotonic waveguide on the PIC chip and the optimum angle of the fiber taper can change depending on the shape of the waveguide that the fiber will be coupled to.

Referring again to FIGS. 2A-3D, depicted are various embodiments of the optical fiber 10 having different configurations of the glass portion 16 and the polymeric portion 20. In order for the flat core surface 26 of the core 18 and/or the flat cladding surface 62 to get close enough to the waveguide surface 46 (FIG. 4) of the waveguide 38 (FIG. 4) to facilitate evanescent coupling, the core 18 and inner cladding 54 may take a variety of cross-sectional shapes configured to expose the core surface 26 and/or cladding surface 62 once the polymeric portion 20 has been stripped off. The cross-sectional shape of the core 18 may be D-shaped, such that the core surface 26 extends along at least a portion of the core 18.

The cross-sectional shape of the core 18 and/or the glass portion 16 may be developed in the preform stage of the optical fiber 10, and the core 18 and/or the glass portion 16 of the preform may have specific geometries applied to maintain the core surfaces 26 of the core 18 during production of the optical fiber 10. The core 18 may have a diameter, largest straight line dimension or width of the flat surface 26 of about 3 μm, 4 μm, 5 μm, 6 μm, about 7 μm, about 8 μm, about 9 μm, about 10 μm, about 11 μm, or about 12 μm. The diameter of the core 18 may be large enough such that the mode field diameter of the core 18 is approximately that of a single mode fiber. The diameter of the core 18 may also be configured for specific design purposes to have a large or small mode field diameter. The outer diameter of the optical fiber 10 may be greater than about 50 μm, or greater than 80 μm, greater than about 100 μm, greater than about 110 μm, greater than about 120 μm, greater than about 130 μm or greater than about 140 μm. In a specific example, the outer diameter of the optical fiber 10 may be about 125 μm.

Referring now to FIGS. 3A-3C, as explained above, the cladding 22 of the optical fiber 10 may be divided into the inner cladding 54 and the outer cladding 58 (e.g., polymeric portion 20). The outer cladding 58 may include a glass, a polymeric material or composites thereof. The polymeric material may include high density polyethylene, low density polyethylene, polystyrene, polymethylmethacrylate, nylon, acrylate, silicone, silicone based materials, fluorinated acrylates, polyimide, ethylene tetrafluoroethylene, fluoroacrylate, fluoromethacrylate and combinations thereof. The polymeric material may be optically transparent. The polymeric portion 20 may have a diameter ranging from between about 40 μm and about 500 μm, between about 80 μm and about 250 μm or between about 100 μm and 150 μm. In a specific example, the polymeric portion 20 is sufficiently thick that the core 18 and the cladding 22 have a diameter of about 125 μm. A polymeric jacket may be disposed around the outer cladding 58. The polymeric jacket may have a lower optical transparency than the outer cladding 58. The polymeric portion 20 may have a refractive index only slightly above or below that of the inner cladding 54. The inner cladding 54 may include a glass or material other than polymers such that the cladding 22 is a composite cladding 22. The inner cladding 54 may have a shape similar to that of the core 18 of FIG. 3C. The diameter, or longest cross-sectional length, of the inner cladding 54 may range from between about 15 μm to about 170 μm, from about 20 μm to about 150 μm, from about 30 μm to about 140 μm, from about 40 μm to about 125 μm or from about 50 μm to about 115 μm. The inner cladding 54 may have a refractive index the same or substantially similar to that of the outer cladding 58. In some embodiments, the outer cladding 58 may have a lower refractive index than the inner cladding 54 (e.g., to prevent tunneling loss). In the depicted embodiments, the D-shape of the inner cladding 54 defines the cladding surface 62 which is configured to intimately couple with the waveguide surface 46 (FIG. 1) of the waveguide 38 (FIG. 1). It will be understood that in embodiments not utilizing the inner cladding 54, the cladding 22 or outer cladding 58 may define the cladding surface 62. The cladding surface 62 may be offset from the core surface 26 of the core 18 (FIGS. 3A and 3B) or may be in line, or aligned with, the core surface 26 (FIG. 3C). The cladding surface 62 may be offset from the core surface 26 of the core 18 by between about 0.1 μm and about 10 μm, or between about 1 μm and about 5 μm. If very strong coupling between the optical fiber 10 and the waveguide 38 is desired, the example depicted in FIG. 3C may be used. The outer cladding 58 may have a diameter of between about 25 μm and about 500 μm, or between about 50 μm and about 250 μm or between about 100 μm and about 125 μm.

The polymeric portion 20 may be removed from the optical fiber 10 to form the stripped portion 28 via a variety of methods. In a first example, the polymeric portion 20 may be stripped from the core 18 using one or more laser beams. For example, the laser beams may emanate from a gas laser (e.g., CO2, Ar, HeNe, HeAg and/or NeCu), a chemical laser, an excimer laser, a solid state laser and/or other sources of laser beams. For example, one or more laser beams 66 may be directed at the polymeric portion 20. The difference in optical absorption and/or evaporation temperature between the material of the polymeric portion 20 and the glass portion 16 (e.g., core 18 and inner cladding 54 (FIG. 3A)) permits selective or preferential removal of the polymeric portion 20 or outer cladding material 58 (FIG. 3A). In another embodiment, a chemical etchant (e.g., methylene chloride) may be applied to the optical fiber 10 which is configured to preferentially remove the polymeric portion 20 without damaging the core 18. In yet another embodiment, the polymeric portion 20 may be thermally stripped from the core 18 using a thermal stripping tool. The thermal stripper may melt or soften the polymeric portion 20 without softening the core 18 such that the polymeric portion 20 may be removed without damaging the core 18 or inner cladding 54. In yet another embodiment, the polymeric portion 20 may be mechanically removed from the core 18 or inner cladding 45 via grinding, slicing, stripping, a miller stripper and/or other acceptable methods.

In some embodiments, taper in the optical fiber was made by HF etching. The taper angle in the fiber may be, for example, 1.5-4 degrees. The taper angles in the waveguide and the optical fiber are preferably optimized to maximize the power transfer efficiency between the waveguide and the optical fiber.

In embodiments utilizing the inner cladding 54, the cladding surface 62 may be polished post stripping to ease coupling of the optical fiber 10 to the waveguide 38.

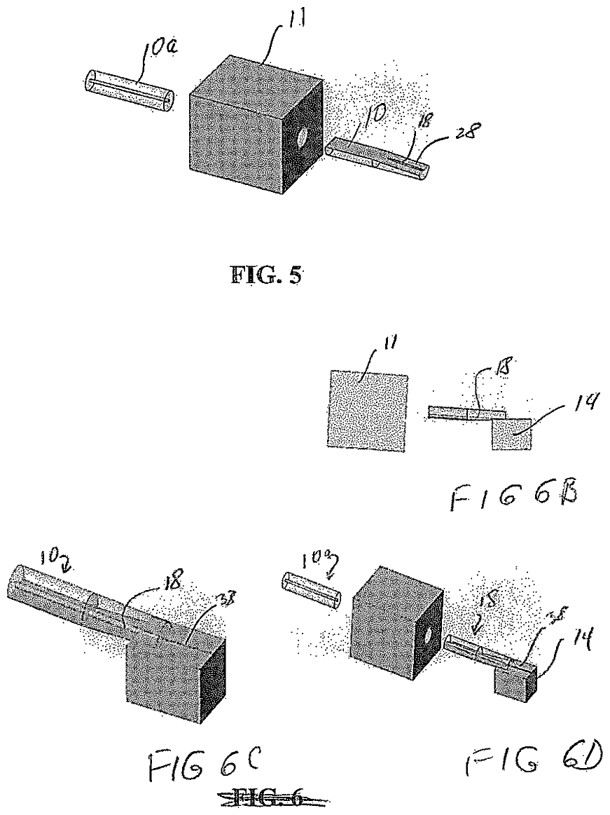

Referring now to FIG. 5, the optical fiber 10 may be coupled to a second optical fiber 10a, for carrying optical signals to and from the photonic integrated circuit 14, such that it is sandwiched between the optical fiber 10a the photonic integrated circuit 14. FIG. 5 schematically one example assembly which has a tapered end of a D-shaped fiber and a standard single mode optical fiber on the other. The single mode fiber and the D-shaped fiber are mechanically coupled using a fiber connector, for example by utilizing a single mode to a D-shape fiber coupler. The exposed core at the tapered and/or stripped portion the optical fiber 10 interfaces with the waveguide 38 as described below.

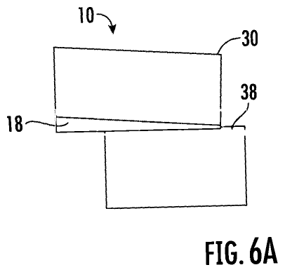

Referring now to FIGS. 6A-6D,once the polymeric portion 20 has been stripped from the optical fiber 10 to form the stripped portion 28 (FIG. 1), the stripped portion 28 may be positioned adjacent to the waveguide 38 to may evanescently couple the core 18 of the optical fiber 10 to the waveguide 38 of the photonic integrated circuit 14. It will be understood that a high index coupling agent (e.g., an epoxy) may be disposed between the core 18 and/or inner cladding 54 (FIG. 1) and the waveguide 38 to counter to enable more efficient coupling.

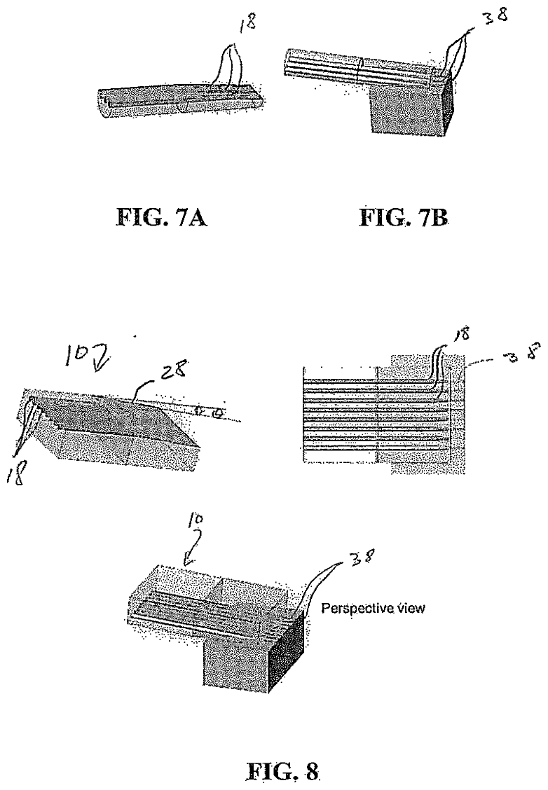

FIG. 7A illustrates schematically a tapered D-shaped fiber 10 with three cores 18. The three cores 18 can be aligned simultaneously to three nanophotonic waveguides in a PIC chip as shown in FIG. 7B. This has significant advantage over configuration which three separate tapered (conical) fibers needed to be aligned separately with respect to waveguides. It greatly simplifies the assembly of coupling fibers to an array of waveguides on a PIC chip (not to scale).

The spacing between the three cores in the tapered D-shaped fiber 10 can be made exact by design and can be made to match exactly with the spacing between waveguides in a lithographically patterned waveguide array on the PIC chip. The fiber and the PIC chip need to be positionally adjusted only once for optimizing the coupling between three cores in the fiber and three waveguides. This is in comparison with the need to positionally adjust three times to align three separate conical fibers to three waveguides in a waveguide array.

FIG. 8 also illustrates a multiple waveguides coupled to a ribbon of multiple D-shaped fibers and assembly with a PIC chip comprising an array of eight waveguides. The fiber cores can be aligned simultaneously to the eight waveguides on a PIC chip.

More specifically, FIG. 8 fiber comprises eight fiber in a ribbon formed by a matrix material, for example a polymer material, or a glass material. The spacing between the three cores in the tapered D-shaped fiber can be made exact by design and can be made to match exactly with the spacing between waveguides in a lithographically patterned waveguide array on the PIC chip. The fiber and the PIC chip need to be positionally adjusted only once for optimizing the coupling between three cores in the fiber and three waveguides. This is in comparison with the need to positionally adjust eight times to align eight separate comparison conical fibers to eight waveguides in a waveguide array. This approach will enable easy, accurate, efficient and inexpensive way for coupling optical signals to PIC, and may be utilized both in quantum communications or quantum computing applications as well as and classical networking and communication applications.

Use of the present disclosure may offer several advantages over existing techniques for coupling optical fibers 10 to photonic integrated circuits 14 and to other optical fibers. First, evanescent coupling allows for in plane light output, broadband optical performance, and low optical loss. Use of evanescent coupling allows for potentially no loss of optical power. Because of the ease and simplicity of this approach, the fiber to waveguide couplers described significant advantages in the PIC applications in quantum and classical networking and communication.

Further, use of the polymeric portion 20 having the stripped portion 28 may allow for quick, easy and accurate placement of the optical fiber 10 within the photonic integrated circuit 14 or to another optical fiber. The profiled shapes disclosed herein allow for the macro-nature of the optical fiber 10 to be retained (e.g., the cladding 22 and/or polymeric portion 20) while providing structures (e.g., the D-shape of the optical fiber 10) that facilitate micro-precision placement (e.g., the core surface 26 or the cladding surface 62 proximate the waveguide surface 46 of the waveguide 38). Additionally, by leveraging the highly accurate fiber drawing process, the coupling loss of the optical fiber 10 to the waveguide 38 due to the highly uniform core surface 26 and cladding surface 62 may be minimal and highly repeatable.

While the embodiments disclosed herein have been set forth for the purpose of illustration, the foregoing description should not be deemed to be a limitation on the scope of the disclosure or the appended claims. It will be apparent to those skilled in the art that various modifications and variations can be made without departing from the spirit or scope of the claims.

It will be understood by one having ordinary skill in the art that construction of the described disclosure and other components is not limited to any specific material. Other exemplary embodiments of the disclosure disclosed herein may be formed from a wide variety of materials, unless described otherwise herein. In this specification and the amended claims, the singular forms “a,” “an,” and “the” include plural reference unless the context clearly dictates otherwise.

Where a range of values is provided, it is understood that each intervening value, to the tenth of the unit of the lower limit, unless the context clearly dictates otherwise between the upper and lower limit of that range, and any other stated or intervening value in that stated range, is encompassed within the disclosure. The upper and lower limits of these smaller ranges may independently be included in the smaller ranges, and are also encompassed within the disclosure, subject to any specifically excluded limit in the stated range. Where the stated range includes one or both of the limits, ranges excluding either or both of those included limits are also included in the disclosure.

For purposes of this disclosure, the term “coupled” (in all of its forms: couple, coupling, coupled, etc.) generally means the joining of two components (optical, electrical or mechanical) directly or indirectly to one another. Such joining may be stationary in nature or movable in nature. Such joining may be achieved with the two components (optical, electrical or mechanical) and any additional intermediate members being integrally formed as a single unitary body with one another or with the two components. Such joining may be permanent in nature, or may be removable or releasable in nature, unless otherwise stated. It will be apparent to those skilled in the art that various modifications and variations can be made without departing from the spirit or scope of the claims.

For the purposes of describing and defining the present teachings, it is noted that the terms “substantially” and “approximately” are utilized herein to represent the inherent degree of uncertainty that may be attributed to any quantitative comparison, value, measurement, or other representation. The term “substantially” and “approximately” are also utilized herein to represent the degree by which a quantitative representation may vary from a stated reference without resulting in a change in the basic function of the subject matter at issue.

It is to be understood that variations and modifications can be made on the aforementioned structure without departing from the concepts of the present invention, and further it is to be understood that such concepts are intended to be covered by the following claims unless these claims by their language expressly state otherwise.

What is claimed is:

1. A fiber to waveguide coupler comprising:
A non-circularly shaped optical fiber having a core and a cladding, at least one of the core and the cladding defining a substantially flat surface angled with respect to an axis of the optical fiber, wherein the optical fiber defines a stripped portion substantially free of the cladding configured to expose the at least one substantially flat surface of the core; and
a waveguide situated adjacent to the core and configured to evanescently couple with the fiber through the exposed at least one substantially flat surface of the core.

2. The fiber to waveguide coupler of claim 1, wherein the optical fiber cladding has a D-shape cross-section.

3. The fiber to waveguide coupler of claim 1, wherein at least a portion of the optical fiber is tapered.

4. The fiber to waveguide coupler of claim 1, wherein the cross-sectional shape of the optical fiber at the stripped portion is substantially a D-shape.

5. The fiber to waveguide coupler of claim 4, wherein at least a portion of the optical fiber is tapered.

6. The optical fiber of claim 1, wherein the cross-section of the core has a minimum width of less than 7 μm.

7. The fiber to waveguide coupler of claim 1, wherein the cross-section of the core has a minimum to maximum width ratio R, and 0.5<R<1.

8. The fiber to waveguide coupler of claim 1, wherein the fiber comprises an outer cladding diameter of between about 50 μm and about 150 μm.

9. The fiber to waveguide coupler of claim 1, wherein the waveguide is a planar waveguide positioned on a photonic integrated circuit.

10. A method of evanescent coupling comprising the steps:
providing an optical fiber having a non-symmetrical cross-section, a core, and a cladding; the core comprising glass, wherein at least one of the core and the cladding defining a substantially flat surface angled with respect to an axis of the optical fiber, wherein the optical fiber defines a stripped portion substantially free of the cladding configured to expose the substantially flat surface of the core;
providing a photonic integrated circuit comprising a waveguide;
positioning the stripped portion of the optical fiber such that the substantially flat surface is proximate the waveguide and the core is evanescently coupled with the waveguide.

11. The method of claim 10, wherein the waveguide is a planar waveguide positioned on a photonic integrated circuit and wherein the cladding's diameter is between about 100 μm and about 150 μm.

12. The method of claim 10, wherein the optical fiber is tapered.

13. The method of claim 11, wherein a cross-sectional shape of the optical fiber is a D-shape.

14. A method of evanescent coupling comprising the steps:
providing an optical fiber having a core and cladding, the core comprising glass,
providing a photonic integrated circuit comprising a waveguide;
stripping at least a portion of the cladding to form a substantially flat and angled surface that is angled relative to fiber axis and to expose the at least a portion the core; and
positioning the stripped portion of the optical fiber such that the substantially flat and angled surface is proximate the waveguide and the core is evanescently coupled with the waveguide.

15. An optical fiber comprising:
a glass core; and
a D-shaped cladding, wherein a portion of the cladding defines a substantially flat surface angled to an axis of the optical fiber.

16. The optical fiber of claim 15 further comprising:
a stripped portion where the outer cladding is removed to expose a portion of the substantially flat surface.

17. The optical fiber of claim 16, wherein a cross-sectional shape of the optical fiber at the stripped portion is substantially a D-shape.

18. The optical fiber of claim 17, wherein the fiber is tapered.

19. The optical fiber of claim 18, wherein the fiber comprises an outer cladding, and the outer cladding has a diameter between about 100 μm and about 150 μm.
